(19) United States
(12) Patent Application Publication
(10) Pub. No.: US 2017/0182610 A1
(43) Pub. Date: Jun. 29, 2017

(54) DRIVE DEVICE FOR CLAMP DEVICE

(71) Applicant: KAN-U INDUSTRY CO., LTD., Shizuoka (JP)

(72) Inventors: Kuraji OKEDA, Shizuoka (JP); Masahiro OKEDA, Shizuoka (JP)

(21) Appl. No.: 15/318,516

(22) PCT Filed: Aug. 26, 2015
(86) PCT No.: PCT/JP2015/073984

§ 371 Date: Dec. 13, 2016

(30) Foreign Application Priority Data
Sep. 16, 2014 (JP) 2014-187294

(51) Int. Cl. B23Q 3/06; B65G 17/12

(52) U.S. Cl. CPC B23Q 3/06; B65G 17/12; B25B 5/04

(57) ABSTRACT

A driving device for a clamping device includes a pulley that rotates around the same axis as a drive shaft, a wire tensioned around the pulley, and wire drive means that pushes and pulls the wire. The wire is provided with engaging members at a predetermined pitch, the engaging member being engaged with the pulley, the pulley is rotated by pushing and pulling of the wire, and a drive shaft is rotationally driven. In addition, the engaging member is in a cylindrical shape, a columnar cylindrical shape, or a spherical shape, a tension surface of the wire of the pulley is provided with recesses, and the engaging members are caught in the respective recesses of the tension surface.

### TECHNICAL FIELD

The present disclosure relates to a driving device for a clamping device that has a holding member clamping a workpiece upon rotational driving of a drive shaft.

### BACKGROUND ART

Conventionally, clamping devices have been utilized for various manufacturing devices and jigs. In addition, there is a method for manually actuating such a clamping device, and a method for actuating the clamping device using a separate driving device. For example, Patent Literature 1 discloses a chuck mechanism applied for a chuck device in which the chuck mechanism serving as a clamping device, and an electric cylinder are disposed so as to be apart from each other, and the chuck mechanism and the electric cylinder are to be driven and linked via a wire.

In addition, Patent Literature 2 discloses a clamping device in which dampers are collectively connected with a wire drive unit via a control wire, a wire is pulled by a contraction action of a clamp cylinder, thereby simultaneously causing each of the dampers to perform clamping actions. According to conventional driving devices for a clamping device as explained above, the clamping device is actuated by the forward and backward movements of a cylinder.

### CITATION LIST

### Patent Literature

Patent Literature 1: Unexamined Japanese Patent Application Kokai Publication No. 2002-11631

Patent Literature 2: Unexamined Japanese Patent Application Kokai Publication No. 2005-279799

### SUMMARY OF INVENTION

### Technical Problem

However, according to the conventional driving devices for a clamping device, the clamping device is actuated by forward and backward movements. Thus, the conventional driving devices are unable to actuate a clamping device with a structure that has a holding member clamping a workpiece upon rotational driving of a drive shaft, or need a complex structure in order to enable the actuation.

The present disclosure has been made in view of the aforementioned circumstances, and the present disclosure is to provide a driving device for a clamping device capable of easily actuating a clamping device that has a holding member clamping a workpiece upon rotational driving of a drive shaft.

### Solution to Problem

A driving device for a clamping device as described in claim 1 includes a pulley that rotates around a same axis as a drive shaft, a wire tensioned around the pulley, and wire drive means that pushes and pulls the wire, wherein the wire is provided with engaging members at a predetermined pitch, the engaging member being engaged with the pulley, the pulley is rotated by pushing and pulling of the wire, and the drive shaft is rotationally driven.

The clamping-device driving device as described in claim 2, wherein the engaging member is in a cylindrical shape, a columnar cylindrical shape, or a spherical shape, a tension surface of the wire of the pulley is provided with recesses, and the engaging members are caught in the respective recesses of the tension surface.

The clamping-device driving device as described in claim 3, wherein a wall is provided at a part of an outer periphery of the tension surface of the pulley at an external side, and the wire is held at a portion in a groove shape formed between the tension surface and the wall.

The clamping-device driving device as described in claim 4 includes a wire guide that confines two lines of the wire tensioned around the pulley so as to be located close to each other in a vicinity of the pulley.

### Advantageous Effects of Invention

According to the present disclosure, a clamping device that has a holding member clamping a workpiece upon rotational driving of the drive shaft can be easily actuated.

### BRIEF DESCRIPTION OF DRAWINGS

FIG. 1 is a perspective view illustrating an example driving device for a clamping device according to the present disclosure;

FIG. 2 is a perspective view illustrating an actuating condition of the driving device for the clamping device;

FIG. 3 is an explanatory view illustrating a non-clamping condition of the driving device for the clamping device;

FIG. 4 is an explanatory view illustrating a non-clamping condition of the driving device for the clamping device;

FIG. 5 is an explanatory view illustrating a clamping condition of the driving device for the clamping device; and

FIG. 6 is an explanatory view illustrating a clamping condition of the driving device for the clamping device.

### DESCRIPTION OF EMBODIMENTS

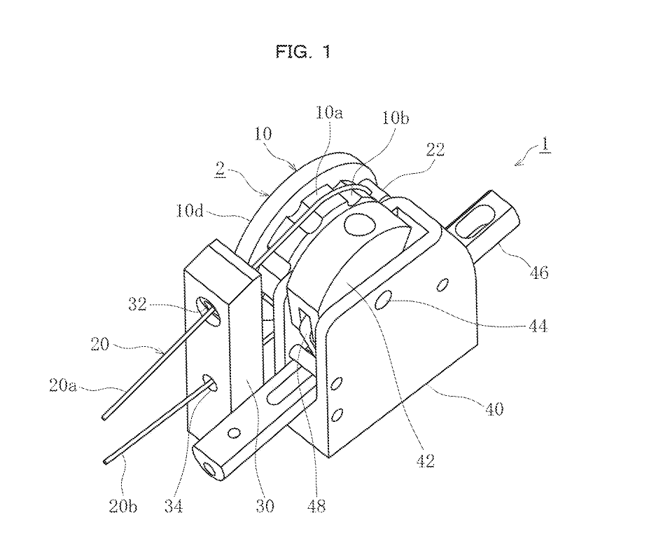

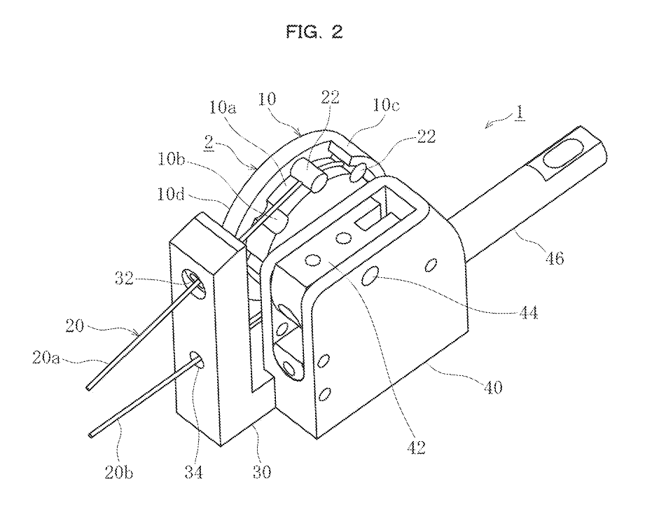

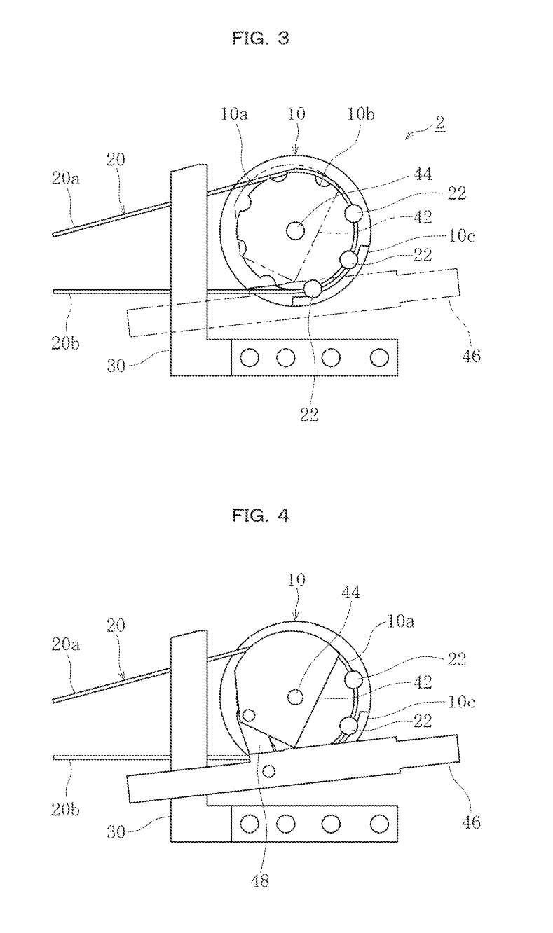

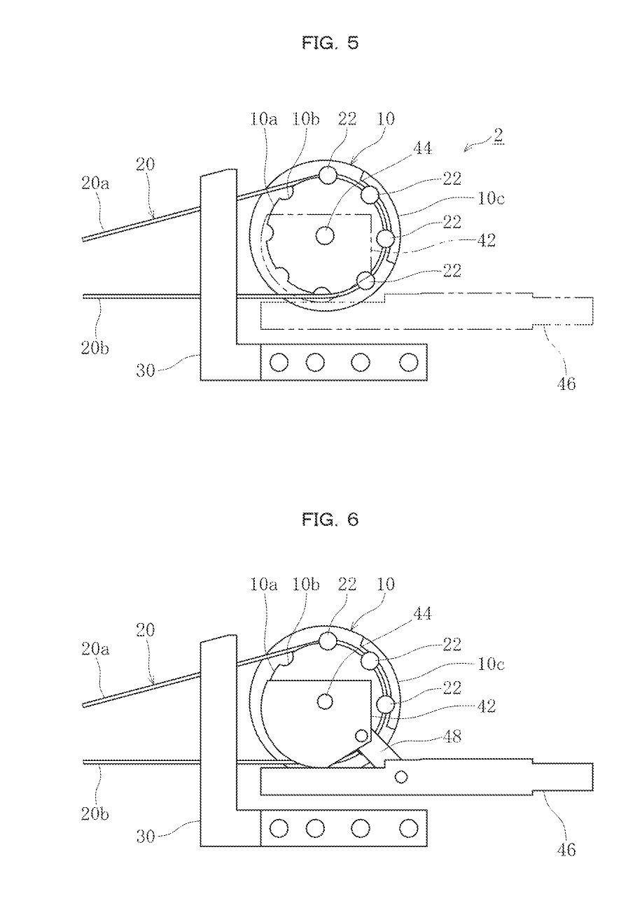

Hereinafter, embodiments of the present disclosure will be described in detail with reference to the accompanying figures. FIG. 1 is a perspective view illustrating an example driving device for a clamping device according to the present disclosure. FIG. 2 is a perspective view illustrating an actuating condition of the driving device for the clamping device. FIG. 3 and FIG. 4 are explanatory views illustrating a non-clamping condition of the driving device for the clamping device. FIG. 5 and FIG. 6 are explanatory views each illustrating a clamping condition of the driving device for the clamping device.

A clamping device 1 in the figures includes a cam shaft 44 that is a drive shaft to be rotationally driven, and clamps a workpiece by a slide bar 46 that is a holding member. The clamping device 1 includes, more specifically, a cam 42 that is rotatably supported by a clamping device main body 40 via the cam shaft 44, and the slide bar 46 that is linked with the cam 42 via a linkage arm 48. In addition, a rotation of the cam 42 causes a stroke action of the slide bar 46 so as to move backwardly and forwardly relative to the workpiece.

Still further, a driving device 2 for the clamping device 1 is to drive a type of clamping device 1 that clamps a workpiece by a rotation of the drive shaft. Thus, the driving device 2 of the present disclosure is applicable to the clamping device that has the holding member clamping a workpiece upon rotational driving of the drive shaft. However, as long as the clamping device has the aforementioned structure, the present disclosure is not limited to the clamping device 1 of this embodiment.

The driving device 2 includes a pulley 10 that rotates around the same axis as the cam shaft 44 that is the drive shaft, a wire 20 tensioned around the pulley 10, and wire drive means (unillustrated) for pushing and pulling the wire 20. As for the wire drive means, as long as the wire 20 can be pushed and pulled, any means is applicable. For example, the wire drive means to be actuated with a manual handle, or the wire drive means that is hydraulically or electrically actuated to push and pull the wire 20 may be applied. In addition, a structure that allows the wire drive means to actuate the multiple driving devices 2, and to simultaneously drive the multiple clamping devices 1 may be applied.

The wire 20 is provided with engaging members 22 at a predetermined pitch, and the engaging members 22 are engaged with the pulley 10. More specifically, a structure is employed in which the engaging member 22 has a cylindrical shape, a columnar cylindrical shape, or a spherical shape (in this embodiment, a columnar cylindrical shape), a tension surface 10a for the wire 20 of the pulley 10 includes recesses 10b, and the engaging member 22 is caught in the recess 10b in the tension surface 10a.

In addition, a side surface of the pulley 10 at the opposite side to the clamping device 1 includes a side plate 10d, and a part of the outer periphery of the tension surface 10a of the pulley 10 at the external side includes a wall 10c so as to rise up on the side plate 10d. In addition, the wire 20 is held at a groove portion formed between the tension surface 10a and the wall 10c.

Still further, a wire guide 30 is provided in such a way that two lines 20a, 20b of the wire 20 tensioned around the pulley 10 are confined so as to be located close to each other in the vicinity of the pulley 10. The wire guide 30 is formed with confining holes 32, 34 close to each other in a bar-shaped member, and the lines 20a, 20b of the wire 20 respectively pass through the confining holes 32, 34, thereby confining the two lines 20a, 20b of the wire 20 to be located close to each other.

Next, an action of the driving device 2 of the clamping device 1 with the aforementioned structure will be explained. First, an explanation is given of a case in which the clamping device 1 as shown in FIG. 1, FIG. 3, and FIG. 4 is in a non-clamping condition. The condition in FIG. 1, FIG. 3, and FIG. 4 is that, at the clamping-device-1 side, the linkage arm 48 lifts up the slide bar 46 with the slide bar 46 that is not abutting the cam 42, and thus the non-clamping condition is achieved.

In this condition shown in FIG. 1, FIG. 3, and FIG. 4, when the line 20a side of the wire 20 is pulled using the wire drive means, the wire 20 rotates the pulley 10, and the cam shaft 44 that is the drive shaft is rotationally driven. In particular, since the recesses 10b in the tension surface 10a of the pulley 10 are engaged with the engaging members 22 of the wire 20, the wire 20 surely and precisely rotates the pulley 10.

By rotationally driving the cam shaft 44, the cam 42 also rotates. In this case, as shown in FIG. 2, FIG. 5, and FIG. 6, the cam 42 abuts the slide bar 46, and pushes down a leading end of the slide bar 46. Thus, the clamping condition of the clamping device 1 is achieved.

Note that to achieve the non-clamping condition of the clamping device 1, the line 20b side of the wire 20 is pulled using the wire drive means, allowing the wire 20 to rotate the pulley 10 in the opposite direction to the prior direction, and to rotate the cam 42 via the cam shaft 44. This causes the cam 42 to be in the condition not abutting the slide bar 46. In addition, the linkage arm 48 lifts up the slide bar 46, and thus the non-clamping condition is achieved.

The driving device 2 for the clamping device 1 according to the aforementioned embodiment includes the pulley 10 that rotates around the same axis as the cam shaft 44 that is the drive shaft, the wire 20 tensioned around the pulley 10, and the wire drive means (unillustrated) for pushing and pulling the wire 20. The wire 20 is provided with the engaging members 22 at a predetermined pitch, the engaging members 22 are engaged with the pulley 10, the pulley 10 is rotated by pushing and pulling the wire 20, and the cam shaft 44 is rotationally driven, thereby easily actuating the clamping device 1 that clamps a workpiece upon rotational driving. In addition, the engaging members 22 surely and accurately rotate the pulley 10, thereby surely actuating the clamping device 1.

Still further, the engaging member 22 has a cylindrical shape, a columnar cylindrical shape, or a spherical shape, the tension surface 10a for the wire 20 of the pulley 10 includes the recesses 10b, and the engaging members 22 are engaged with the recesses 10b of the tension surface 10a, and thus more sure and precise actuation is accomplished.

Yet still further, a part of the outer periphery of the tension surface 10a of the pulley 10 at the external side is provided with the wall 10c, and the wire 20 is held at a groove portion formed between the tension surface 10a and the wall 10c, and thus the wire 20 is prevented from being disengaged from the pulley 10 during the actuation.

Moreover, by providing the wire guide 30 that confines the two lines 20a, 20b of the wire 20 tensioned around the pulley 10 so as to be located close to each other in the vicinity of the pulley 10, the area for pulling and winding the wire 20 can be reduced. In addition, by having the two lines 20a, 20b of the wire 20 bind together so as to be located close to each other in the vicinity of the pulley 10, the wire 20 can be prevented from being disengaged from the pulley 10 during the actuation.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present application claims the benefit of Japanese Patent Application No. 2014-187294 filed on Sep. 16, 2014. The entire contents of Japanese Patent Application No. 2014-187294 including specification, claims, and drawings are hereby incorporated by reference in this specification.

### INDUSTRIAL APPLICABILITY

As described above, according to the present disclosure, the driving device for a clamping device capable of easily actuating the clamping device that has a holding member clamping a workpiece upon rotational driving of a drive shaft can be provided.

### REFERENCE SIGNS LIST

1 Clamping device

2 Driving device

10 Pulley

10a Tension surface

10b Recess

10c Wall

10d Side plate

20 Wire

20a Line

20b Line

22 Engaging member

30 Wire guide

32 Confining hole

34 Confining hole

40 Clamping device main body

42 Cam

44 Cam shaft

46 Slide bar

48 Linkage arm

1. A driving device for a clamping device that has a holding member clamping a workpiece upon rotational driving of a drive shaft, the driving device comprising:
a pulley that rotates around a same axis as the drive shaft;
a wire tensioned around the pulley; and
wire drive means that pushes and pulls the wire,
wherein the wire is provided with engaging members at a predetermined pitch, the engaging member being engaged with the pulley, the pulley is rotated by pushing and pulling of the wire, and the drive shaft is rotationally driven.

2. (canceled)

3. The driving device according to claim 1, wherein
a wall is provided at a part of an outer periphery of the tension surface of the pulley at an external side, and
the wire is held at a portion in a groove shape formed between the tension surface and the wall.

4. The driving device according to claim 1, further comprising a wire guide that confines two lines of the wire tensioned around the pulley so as to be located close to each other in a vicinity of the pulley.

5. A driving device for a clamping device that has a holding member clamping a workpiece upon rotational driving of a drive shaft, the driving device comprising:
a pulley that rotates around a same axis as the drive shaft;
a wire tensioned around the pulley; and
wire drive means that pushes and pulls the wire,
wherein
the wire is provided with engaging members at a predetermined pitch, the engaging member being engaged with the pulley, the pulley is rotated by pushing and pulling of the wire, and the drive shaft is rotationally driven,
the engaging member is in a cylindrical shape, a columnar cylindrical shape, or a spherical shape,
a tension surface of the wire of the pulley is provided with recesses, and
the engaging members are caught in the respective recesses of the tension surface.

6. The driving device according to claim 5, wherein
a wall is provided at a part of an outer periphery of the tension surface of the pulley at an external side, and
the wire is held at a portion in a groove shape formed between the tension surface and the wall.

7. The driving device according to claim 5, further comprising a wire guide that confines two lines of the wire tensioned around the pulley so as to be located close to each other in a vicinity of the pulley.
